(19) United States
(12) Patent Application Publication
(10) Pub. No.: US 2026/0208463 A1
(43) Pub. Date: Jul. 23, 2026

(54) PAPER DISH

(71) Applicant: REYNOLDS CONSUMER PRODUCTS LLC, Lake Forest, IL (US)

(72) Inventor: Jonathan Sammon, Lake Forest, IL (US)

(21) Appl. No.: 19/458,247

(22) Filed: Jan. 23, 2026

Related U.S. Application Data
(60) Provisional application No. 63/748,959, filed on Jan. 23, 2025.

(51) Int. Cl. B31F 1/00; B65D 1/34

(52) U.S. Cl. CPC B31F 1/0077; B65D 1/34

(57) ABSTRACT

Paper dishes, such as plates and bowls, can be formed by pressing a flat sheet of paper into a three-dimensional shape. These paper dishes can have a generally square shape with generally straight edges and generally curved corners. In some designs, these paper dishes can have a side wall that varies from a steep wall angle in the straight areas of the dish and a more shallow wall angle in the curved areas or corners. The blank from which the dish is formed can have score lines which guide the formation of pleats in the paper during pressing. The score lines are oriented perpendicular to a baseline that has continuously variable curvature, with tighter curvature in the corners of the plate, and less curvature in the straight sections of the plate. The score lines generally do not share a common center.

### PRIORITY CLAIM

This application claims priority under 35 U.S.C. § 119(e) to U.S. Provisional Application Ser. No. 63/748,959, filed Jan. 23, 2025, which is expressly incorporated by reference herein.

### BACKGROUND

Historically, paper plates and other paper dishes are formed in one of two ways: fluted or smooth scored. Fluted plates have wide, shallow flutes pressed into the paper to provide strength. Smooth scored plates are formed by pressing small score lines radially into the paper plate blank.

Fluted plates are typically very flat, as the paper must be stretched evenly to form the shape of the plate. These are sometimes pressed several plates at a time in a tool (“multi-webbed plates”). They are typically low-cost options made from thin paper.

Smooth scored plates are often stronger, and deeper than fluted plates. During pressing, the paper creases and pleats along these score lines, allowing a tighter, deeper shape to be formed. Depending on the exact equipment and materials used, these pleats may “lock” in place, holding their shape even when loading is applied to the plate. Typically this pleat locking effect happens when heat is applied to a coated paper (often a polymeric coating), which causes the paper to spread and reform; the coating can help “seal” the pleat to the new, folded shape, improving strength. Because this method allows for deeper shapes, both plates and bowls of various sizes can be made using this method. Thicker, stiffer paper may also be used.

Most paper plates on the market are circular, as the shape is radially symmetric and easy to form uniformly in standard presses. This uniformity allows for a strong, repeatable shape to be made. Other shapes may be desirable for other reasons. In particular, a square plate may be desirable because for the same nominal size, a square plate has more surface area. A square plate also has corners, which can make it easier to portion out several different foods in different areas of the plate. A square plate shape may also be easier to produce with less waste, as a square blank shape can more easily be nested onto a paper web, so that the blanks can be cut from a roll of paper with less wasted space in between plates.

Existing square plates typically follow the same design pattern, with long straight sides and relatively sharp, tight corners. This is a relatively old and established design, and is not common for “everyday” plates; it is more common for special use, “party” plates intended for special occasions or printed with bright colors or designs. It may be desirable for a softer design that still meets the stated benefits of a square plate while having a shape that reads as more modern and more suitable for “everyday” use, like the more common circular plate. Furthermore, the relatively sharp corners of a square plate can be challenging to form because of the tight curvature—it is difficult to form paper into a tight curve, as the paper has to be “bunched up” in a series of closely packed pleats (as opposed to a round plate, which has gentle, uniform curvature and can be formed successfully with widely spaced pleats).

Finally, all plates are limited by strength. Plates that can be analytically demonstrated to be stronger have become popular in the market, typically branded as “ultra” strong compared to “everyday” plates. Historically, the “ultra” strong category has been dominated by circular plates, due to the relative simplicity of the shape and many ways this shape can be optimized to work with a heavy, strong paperboard while still forming accurately and holding shape under use. It may be desirable to develop a method of designing “ultra” strong non-circular plate designs, in order to combine the previously-stated benefits of a square plate with the added strength of an “ultra” plate.

### SUMMARY

The present disclosure teaches a smooth scored paper dish with a rounded square shape. The angle of the side wall of the plate is lofted between the rim of the plate and a baseline; these two profiles are not perpendicularly offset from each other and the profiles are chosen so that the side wall is steeper in the straighter sections of the generally square shape, and shallower in the curved corner sections of the rounded square shape.

In illustrative embodiments, the forming blank for the dish is a rounded square, with scores arranged perpendicular to a design baseline. As the baseline is a continuously varying curve, the pleats/score lines do not intersect at a common center. Pleats/score lines can be spaced close together in the curved region of the plate (near the corners) but can be wide apart or omitted entirely in straighter regions.

In illustrative embodiments, the paper dish can be formed to provide a generally flatter plate, a deeper bowl, or other desired dishes such as serving platters etc. In any case, varying profiles and/or scoring of blanks in accordance with the present disclosure can allow for desired shapes of these dishes.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a paper dish illustrating a plate having a rounded square shape with generally straight sides and rounded corners;

FIG. 2 is a cross-sectional view of a portion of the plate in FIG. 1 with an angle B formed between a flat bottom of the plate and a side wall of the plate at the corner of the plate;

FIG. 3 is a cross-sectional view of a portion of the plate in FIG. 1 with an angle C formed between the flat bottom of the plate and the side wall of the plate along a side of the plate showing that the angle C along the side of the plate is larger than the angle B at the corner of the plate;

FIG. 4 is a top plan view of the plate in FIG. 1 showing a baseline in dashed line about which score lines in a blank are arranged to establish the final shape of the plate when pressed in to final form;

FIG. 5 is a top plan view of a blank prior to pressing into the plate of FIGS. 1 and 4 showing that score lines in the blank at a particular corner do not all intersect at a common center and further showing that pleats can be spaced close together in the curved region of the plate (near the corners) but are wide apart or omitted entirely in straighter regions;

FIG. 6 is curvature comb illustration showing a curvature profile of the baseline shown in FIG. 4;

FIG. 7 is a top plan view of another blank similar to the blank of FIG. 5 with annotations illustrating features of the score lines applied to the blank prior to forming into a paper dish;

FIG. 8 is a top plan view of an alternative paper plate with a different baseline shape from the plate in FIG. 1 to accommodate potential manufacturing or aesthetic preferences for plates made in accordance with the present disclosure;

FIG. 9 is a perspective view of another paper dish in accordance with the present disclosure illustrating a bowl having a rounded square shape with generally straight sides and rounded corners; and

FIG. 10 is a side elevation view of the bowl in FIG. 9 showing the depth of the bowl provided.

### DETAILED DESCRIPTION

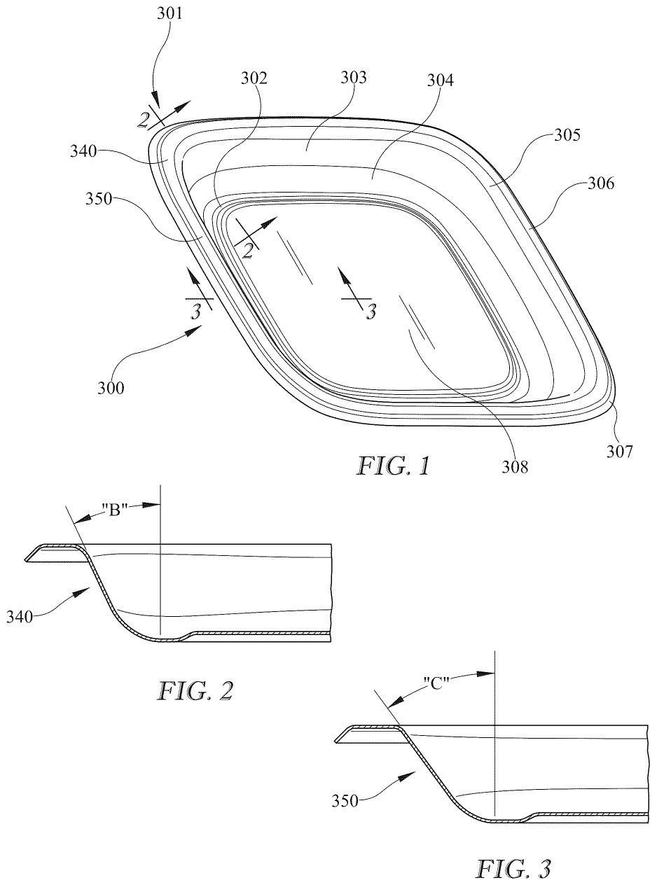

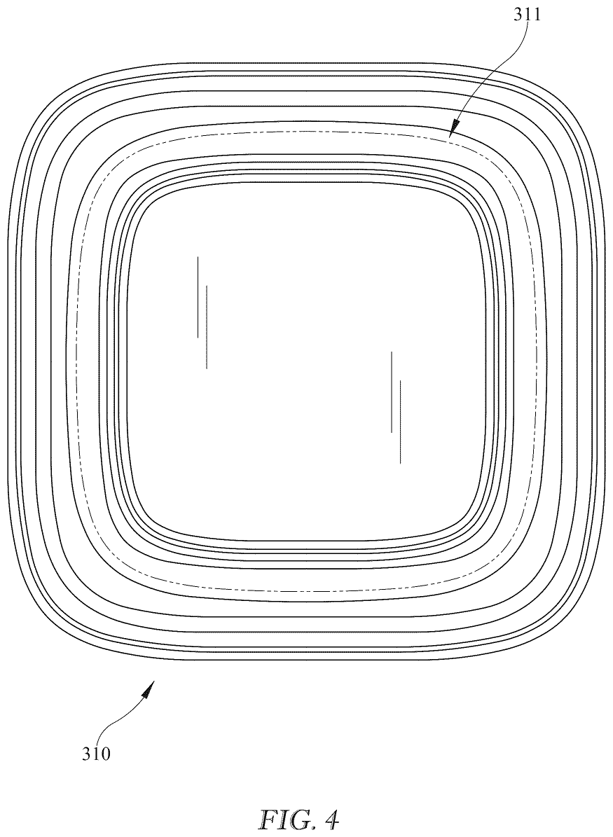

A paper dish in accordance with the present disclosure is illustrated as a plate 300 shown in FIG. 1. Similar to conventional circular and square plates, the plate has an edge 301, a flat bottom 302, a side wall 303, a first curve 304, a second curve 305, and a generally flat rim 306. Most plates will also have a downward flange 307 and a center protrusion 308.

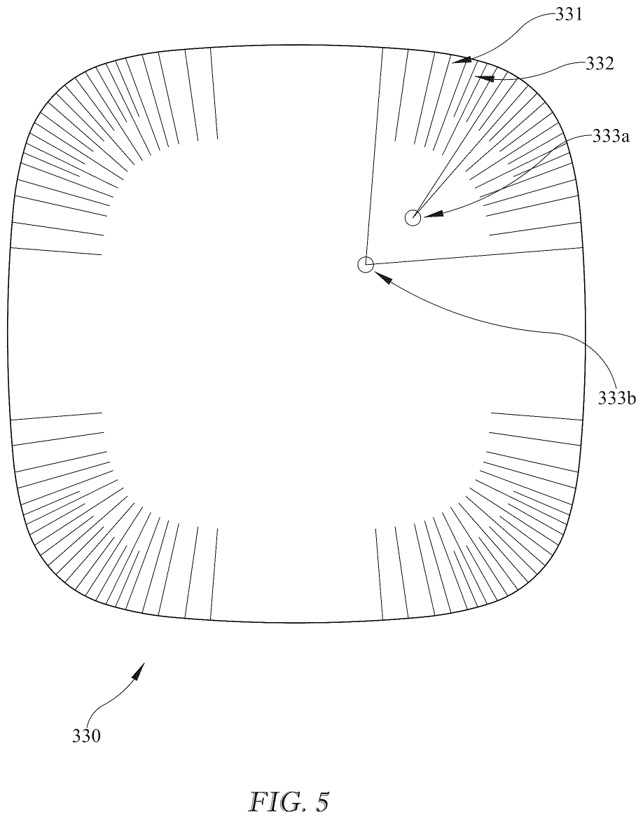

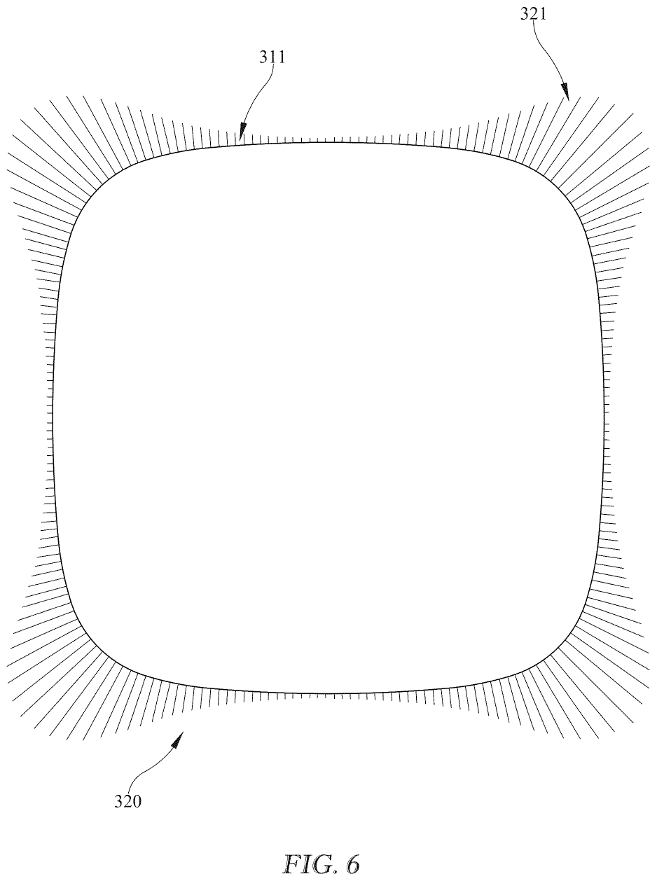

The plate is formed from a blank 330 as shown in FIG. 5. Score lines are arranged around a baseline 311. The change in curvature along this baseline 311 is continuous (at least adjacent to the corners), as indicated by the curvature comb 321 shown in FIG. 6. The curvature is high in the corners and low in the straight areas of the plate, but the change in curvature between these regions is gradual.

The shapes of the edge 301 and the baseline 311 are not directly related. The radii of curvature on the baseline 311 and the outer edge 301 of the plate in the present disclosure may be similar or even identical. The two radii are not necessarily concentric. This choice of baseline and edge shape means that the side wall angle of the plate will be different in different areas of the plate.

In the illustrative plate 300 the baseline 311 is located where the theoretical sharp corner would be if the first curve 304 were not present. However, the baseline may be moved radially in towards the center of the plate or out towards the rim without fundamentally affecting the design. This feature may account for a paper that is more or less resistant to pleating during formation, which may require longer or shorter scores to form properly.

Turning to a blank used to form the plate 300, score lines are laid out perpendicular to the baseline 311, and extend out towards the outer edge. After laying out these score lines, some 331 may extend from baseline to edge whereas others 332 may be shortened so that they do not connect to the baseline and only exist near the edge as suggested in FIG. 5. Note that even if the score lines do not connect to the baseline, they stay perpendicular to the baseline and not necessarily to the outer edge.

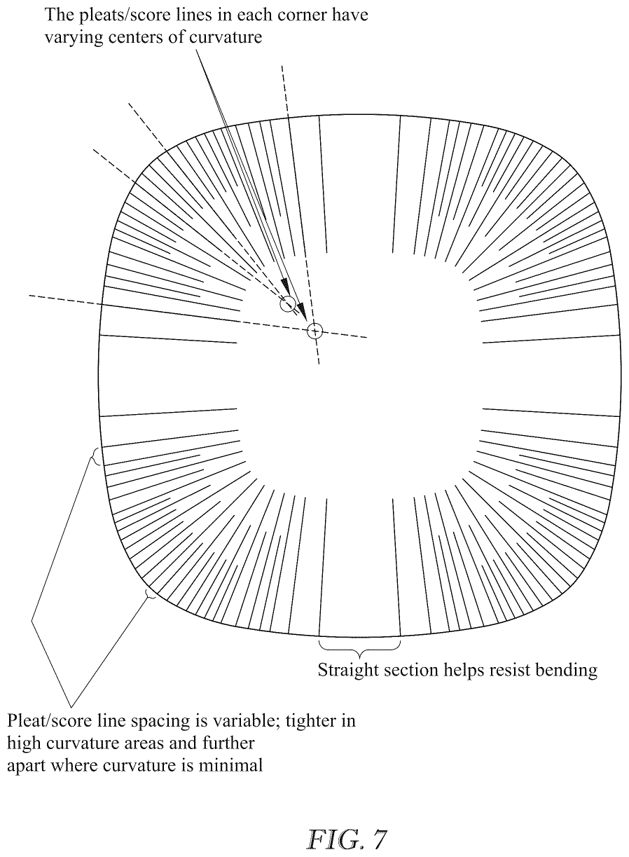

The perpendiculars of the baseline 311 do not have a common center as in a conventional circular design as shown in FIG. 7. Nor do they have four common centers in each of four corners, as in the conventional square design. Instead, the shape shown has a continuously changing center of curvature. Thus tracing out the intersection point 333a and 333b from any two arbitrary score lines will result in a different center as suggested in FIGS. 5 and 7.

These nonconcentric pleats may have beneficial properties. Some conventional paper plates are weakest in bending along score lines, as the lines exist in order to allow the paper to bend during plate formation. If these lines all point to a common center, this can concentrate bending stresses in a single location. Because there is no single center point anywhere on a rounded square plate as described, there is no obvious weak point when bending loads are applied. This can increase the strength, rather than in, for example, some conventional square plates which can concentrate loads in the corners, creating a weak point that can cause the plate to bend undesirably during use.

Because the scores form pleats in highly curved regions of the plate, the score lines can be spaced further apart as the curvature decreases, and may be omitted entirely in the straightest portions of the plate side wall. As noted above, score lines in most designs intentionally break the fiber structure of the paper to form a weak point in order to facilitate pleating. Therefore a long, uninterrupted section on a rounded square plate is relatively strong and resistant to bending/folding compared to a heavily pleated section.

The shape described for this new plate 300 has additional beneficial properties. Consider the side wall 303 angles as measured from the vertical at different points in the plate. For a circular plate, the side wall angle is uniform throughout the plate. For a typical circular plate, the side wall angle has a minimum practical value, typically around 25°, below which it is too difficult to reliably form the paper to the angle without undesirable wrinkling, tearing, requiring too large and expensive of a blank size, or other issues.

The illustrative plate 300 has a side wall 303 that spans the edge 301 and the baseline 311 as shown in FIG. 1. Because these two profiles are independent of each other and are not perpendicularly offset, the side wall angle 303 changes to accommodate the geometry. In 3D modeling, this side wall shape is formed not by a profile sweep, but by a loft between the rim and the baseline.

Consider the cross-section in the straight section of the plate 340. The angle of this side wall is noted as “B” as shown in FIG. 2. In the diagonal cross section 350, the angle of the side wall, “C” is such that C>B as shown in FIG. 3. In the preferred embodiment, “B” is approximately 21.5° and “C” is approximately 33.3°. In the straight section, there's minimal curvature, like the straight section of a square plate. Because the paper doesn't need to stretch significantly, the paper can tolerate an angle greater than the typical 25° limit imposed by traditional plate design.

In the corners, the paper needs to curve more, and a tight angle such as 21.5° could be challenging to form economically. Due to the shape, however, the tight region of the corner has a larger angle that is easily formable (“C,” in one embodiment 33.3°). The shape is such that the wall angle transitions smoothly between the B and C angles. The exact shape of the rim and baselines are chosen such that the angle of the side wall is above the typical minimum (eg, 25°) in the tightly curved regions, but is below this limit in the minimally curved regions of the plate. The angles of the plate therefore combines easily formable, shallow angles in the difficult-to-form, highly curved regions, with steep, strong angles on the straight sections of the plate to improve strength.

It is contemplated that plate users may preferentially hold plates along the straight edges. Therefore, while the corners of the plates may still have shallower side wall angles and therefore weaker performance in the corner axis, the plate may still be stronger when held along the straight sides and therefore loading is more likely to be oriented along the edge, not the corner, axis.

The shallower corners of the rounded square plate design require slightly less paper to form compared to a conventional square paper plate. This results in a blank with less surface area, reducing its weight and cost to manufacture.

The curvature comb shown in 320 is the simplest geometry that meets the requirements of this invention as shown in FIG. 6. However, small changes may be made for other manufacturability or other reasons.

For example, it might be desirable for the approximately straight edges of the square to be perfectly straight over a short distance. These exactly straight edges may be helpful as a locating edge to locate the blank accurately in the press immediately before formation. Therefore, the shape shown in 320 may be approximated to have a short, linear section (for example, in approximately the middle ⅓ of the overall nominal width of the square shape), connected by variable-curvature corners on the outside thirds of the blank. This may result in a blank curvature that has small “spikes” of curvature where the straight section and curved section meet, while the majority of the curvature matches the approximate profile shown in 320.

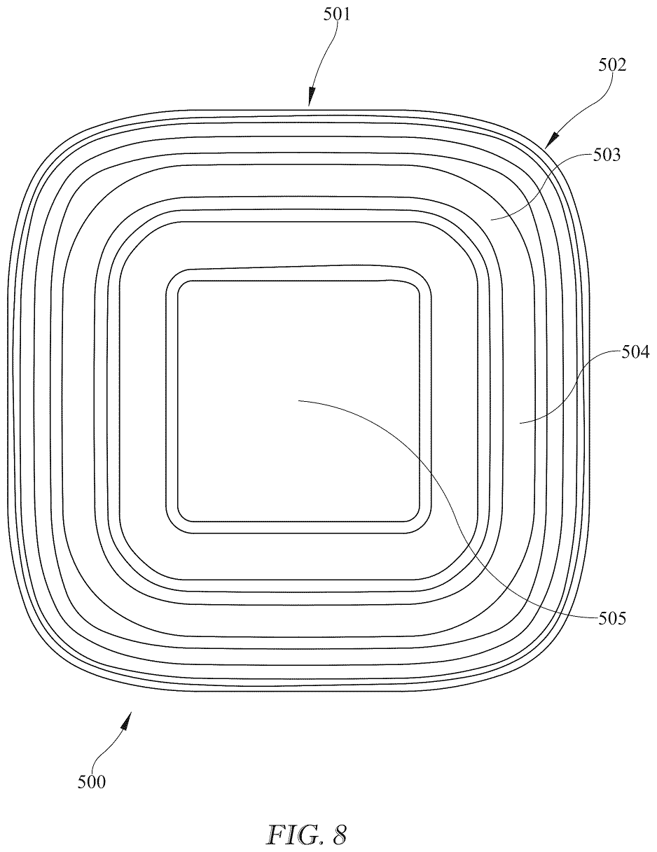

One such alternative design is shown in more detail in FIG. 8. The dotted lines show the boundary between perfectly straight sections 501 and continuously-curved sections 502. Paper in the straight regions 504 and 505 has no curvature in the concentric direction, whereas paper in the corner regions 503 does. All the key features (the center emboss, first and second curves, rim, and flange) are all straight between the dotted lines, and only curve on the outside corners. Note that no pleats whatsoever will be required along the straight sections 501 due to the shape. The blank for this design will have perfectly straight edges, with the width of these straight lines (measured to the tangent point where the curvature starts) equal to the distance between the dotted lines as shown. The design can be modified with the dotted lines being closer together or further apart, to make a design that has larger or smaller straight sections, to meet manufacturability requirements or consumer preference.

Designs illustrated in this disclosure include a continuously curving baseline curvature. It may be desirable to approximate this curvature using a series of constant radii curves rather than a single continuously variable curve. This may be specifically used in order to use G-code which can represent constant radius curves accurately but needs to approximate splines as a series of straight line movements in order to cut a press die using CNC.

The continuously varying curves described in this disclosure can be approximated as three or more radii, each tangent to the next in sequence, with two or more different values for radii (for example, the corner may be modeled as two equal wide radius curves with a small radius curve between them). This is differentiated from a traditional square plate, which uses a single constant radius curve, rather than several in series.

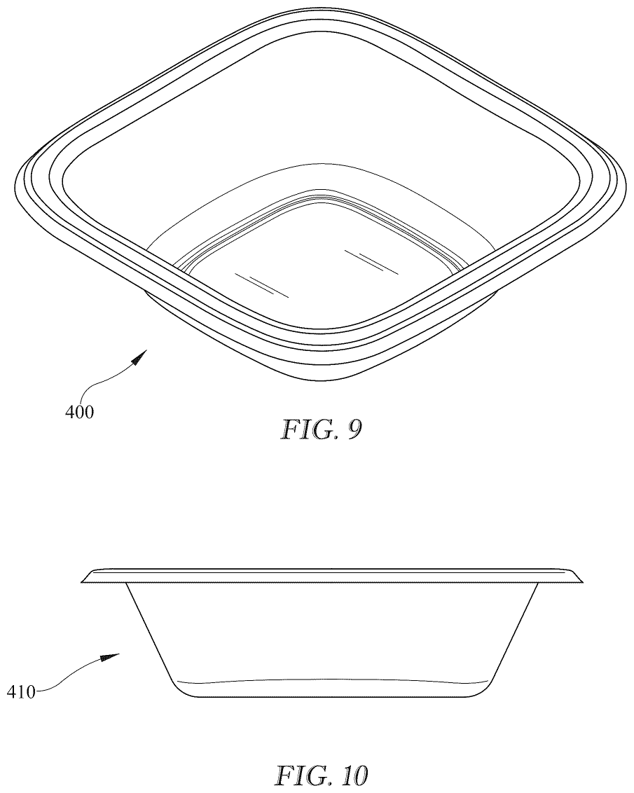

The present disclosure describes the plate 300 as a guiding example. This may be a 9″ or 10″ nominal size. Other sizes, including large serving platters (say, 12″), smaller dessert plates (say, 6″), or generally rectangular trays (say, 9″×12″) can use the same design principles. The overall height/depth of the plate can be increased: For example, a 6″ or 7″ design may have a much larger vertical distance between the rim and the bottom surface, making a deeper plate or a bowl depending on the relative proportion of the depth to nominal size. Bowls are of particular importance to this design concept, as they can be difficult to form without tearing due to the high degree of folding/pleating required to “bunch up” the paper into the correct shape. Therefore an improved system for laying out pleats on a blank is beneficial to forming a strong, aesthetically-pleasing bowl with few wrinkles, tears, or uneven folds and pleats when formed. An example bowl using this same design system is shown in 400 and 410 as shown in FIGS. 9 and 10.

Paper plates are typically made of a coated paper board, such as a clay-coated SBS paper, but they can be made of a wide variety of coated and uncoated papers and boards. The coating may be a polymer laminate, a clay coating, an aqueously-applied coating, or a combination thereof. The coating may be optimized to be compostable, oil resistant, water resistant, repulpable (recyclable), or any combination of these and other properties. The paper may be traditional wood-fiber paper, or may be made of an alternative fiber, such as bagasse or bamboo.

The following clauses outline combinations of features contemplated as part of the present disclosure;

Clause 1. A paper dish comprising
a bottom having four corners and four sides,
a side wall that extends upwardly from the bottom along each of the four corners and four sides of the bottom, wherein a corner angle is formed between a line perpendicular to the bottom and side wall at each of the four corners, a side angle is formed between the line perpendicular to the bottom and the side wall at each of the sides, and the side angle is greater than the corner angle.

Clause 2. The paper dish of clause 1, any other suitable clause, or any suitable combination of clauses, wherein each of the four corners are rounded when viewed from above.

Clause 3. The paper dish of clause 2, any other suitable clause, or any suitable combination of clauses, wherein at least a portion of each of the four sides are straight when viewed from above.

Clause 4. The paper dish of clause 2, any other suitable clause, or any suitable combination of clauses, wherein the corner angle is inclusively between 18 and 25 degrees

Clause 5. The paper dish of clause 2, any other suitable clause, or any suitable combination of clauses, wherein the corner angle is inclusively between inclusively between 20 and 22 degrees.

Clause 6. The paper dish of clause 1, any other suitable clause, or any suitable combination of clauses, wherein the side angle is between 25 and 35 degrees

Clause 7. The paper dish of clause 1, any other suitable clause, or any suitable combination of clauses, wherein the side angle is between 32 and 34 degrees.

Clause 8. The paper dish of clause 1, any other suitable clause, or any suitable combination of clauses, wherein the side wall is formed to include pleats at and adjacent to each of the four corners.

Clause 9. The paper dish of clause 8, any other suitable clause, or any suitable combination of clauses, wherein a first subset of the pleats included at or adjacent to a first one of the four corners can be unfolded and flattened out to expose a plurality of score lines, and wherein tracing out any two arbitrary score lines from the plurality of score lines will result in a different center at the intersection of the any two arbitrary score lines.

Clause 10. The paper dish of clause 8, any other suitable clause, or any suitable combination of clauses, wherein the plurality of score lines are spaced further apart from one another in regions of the first one of the four corners having a first curvature than in regions of the first one of the four corners having a second curvature, the second curvature being higher than the first curvature.

Clause 11. A paper blank adapted to be pressed into a non-round paper dish, the blank comprising
a sheet of fiber based material having four corners and four sides, and
a plurality of score lines formed in the sheet of fiber based material, wherein each of the plurality of score lines extend from an edge of the blank.

Clause 12. The paper blank of clause 11, any other suitable clause, or any suitable combination of clauses, wherein tracing out any two arbitrary score lines from the plurality of score lines located at or adjacent to a first corner of the four corners included in the sheet will result in a different center at the intersection of the any two arbitrary score lines.

Clause 13. The paper blank of clause 12, any other suitable clause, or any suitable combination of clauses, wherein the plurality of score lines are spaced further apart from one another in regions of the first one of the four corners having a first curvature than in regions of the first one of the four corners having a second curvature, the second curvature being higher than the first curvature.

Clause 14. The paper blank of clause 11, any other suitable clause, or any suitable combination of clauses, wherein the plurality of score lines are closer to one another along the edge of the blank near one of the four corners than along the edge of the blank near one of the four sides.

Clause 15. The paper blank of clause 11, any other suitable clause, or any suitable combination of clauses, wherein at least a portion of each of the four sides are straight when viewed from above.

Clause 16. The paper blank of clause 15, any other suitable clause, or any suitable combination of clauses, wherein each of the four corners are rounded when viewed from above between the at least a portion of each of the four sides that are straight when viewed from above.

Clause 17. The paper blank of clause 16, any other suitable clause, or any suitable combination of clauses, wherein there are no score lines that extend from the at least a portion of each of the four sides that are straight when viewed from above.

Clause 18. The paper blank of clause 11, any other suitable clause, or any suitable combination of clauses, wherein each of the plurality of score lines extend perpendicular to a baseline associated with continuous curvature adjacent to each of four corners of a non-round dish formed from the paper blank.

Clause 19. A method of making a non-round paper dish, the method comprising
providing a paper blank, the paper blank including a sheet of fiber based material having four corners and four sides, and a plurality of score lines formed in the sheet of fiber based material, wherein each of the plurality of score lines extend from an edge of the blank toward an intersection point; and
pressing the paper blank so as to form pleats via folds at the plurality of score lines to establish a non-round paper dish, the paper dish including a bottom having four dish corners and four dish sides, a side wall that extends upwardly from the bottom along each of the four dish corners and four dish sides of the bottom, wherein a corner angle is formed between a line perpendicular to the bottom and side wall at each of the four dish corners, a side angle is formed between the line perpendicular to the bottom and the side wall at each of the four dish sides, and the side angle is greater than the corner angle.

Clause 20. The method of clause 19, any other suitable clause, or any suitable combination of clauses, wherein tracing out any two arbitrary score lines from the plurality of score lines located at or adjacent to a first corner of the four corners included in the sheet will result in a different center at the intersection of the any two arbitrary score lines.

While teachings of the present disclosure address the properties and challenges of a pressed paper plate, the same principles may be applicable to other pressed materials, such as a woven fiber, natural sheets (such as a pressed areca palm or thin wood or bamboo veneer), metal foil, or any other sheet material that is pressed into a shape but has limited flexibility and moldability. Moreover, the nonconcentric pleats and a variable side wall angle features provided in this disclosure can be incorporated singly or in combination as part of a dish.

1. A non-round paper dish comprising
a bottom having four corners and four sides,
a side wall that extends upwardly from the bottom along each of the four corners and four sides of the bottom, wherein a corner angle is formed between a line perpendicular to the bottom and side wall at each of the four corners, a side angle is formed between the line perpendicular to the bottom and the side wall at each of the sides, and the side angle is greater than the corner angle.

2. The paper dish of claim 1, wherein each of the four corners are rounded when viewed from above.

3. The paper dish of claim 2, wherein at least a portion of each of the four sides are straight when viewed from above.

4. The paper dish of claim 2, wherein the corner angle is inclusively between 18 and 25 degrees.

5. The paper dish of claim 2, wherein the corner angle is inclusively between inclusively between 20 and 22 degrees.

6. The paper dish of claim 1, wherein the side angle is between 25 and 35 degrees.

7. The paper dish of claim 1, wherein the side angle is between 32 and 34 degrees.

8. The paper dish of claim 1, wherein the side wall is formed to include pleats at and adjacent to each of the four corners.

9. The paper dish of claim 8, wherein a first subset of the pleats included at, or adjacent to, a first one of the four corners can be unfolded and flattened out to expose a plurality of score lines, and wherein tracing out any two arbitrary score lines from the plurality of score lines will result in a different center at the intersection of the any two arbitrary score lines.

10. The paper dish of claim 8, wherein the plurality of score lines are spaced further apart from one another in regions of the first one of the four corners having a first curvature than in regions of the first one of the four corners having a second curvature, the second curvature being higher than the first curvature.

11. A paper blank adapted to be pressed into a non-round paper dish, the blank comprising
a sheet of fiber based material having four corners and four sides, and
a plurality of score lines formed in the sheet of fiber based material,
wherein each of the plurality of score lines extend from an edge of the blank.

12. The paper blank of claim 11, wherein tracing out any two arbitrary score lines from the plurality of score lines located at, or adjacent to, a first corner of the four corners included in the sheet will result in a different center at the intersection of the any two arbitrary score lines.

13. The paper blank of claim 12, wherein the plurality of score lines are spaced further apart from one another in regions of the first one of the four corners having a first curvature than in regions of the first one of the four corners having a second curvature, the second curvature being higher than the first curvature.

14. The paper blank of claim 11, wherein the plurality of score lines are closer to one another along the edge of the blank near one of the four corners than along the edge of the blank near one of the four sides.

15. The paper blank of claim 11, wherein at least a portion of each of the four sides are straight when viewed from above.

16. The paper blank of claim 15, wherein each of the four corners are rounded when viewed from above between the at least a portion of each of the four sides that are straight when viewed from above.

17. The paper blank of claim 16, wherein there are no score lines that extend from the at least a portion of each of the four sides that are straight when viewed from above.

18. The paper blank of claim 11, wherein each of the plurality of score lines extend perpendicular to a baseline associated with continuous curvature adjacent to each of four corners of a non-round dish formed from the paper blank.

19. A method of making a non-round paper dish, the method comprising
providing a paper blank, the paper blank including
a sheet of fiber based material having four corners and four sides, and
a plurality of score lines formed in the sheet of fiber based material, wherein each of the plurality of score lines extend from an edge of the blank toward an intersection point; and
pressing the paper blank so as to form pleats via folds at the plurality of score lines to establish a non-round paper dish, the paper dish including
a bottom having four dish corners and four dish sides,
a side wall that extends upwardly from the bottom along each of the four dish corners and four dish sides of the bottom, wherein a corner angle is formed between a line perpendicular to the bottom and side wall at each of the four dish corners, a side angle is formed between the line perpendicular to the bottom and the side wall at each of the four dish sides, and the side angle is greater than the corner angle.

20. The method of claim 19, wherein tracing out any two arbitrary score lines from the plurality of score lines located at, or adjacent to, a first corner of the four corners included in the sheet will result in a different center at the intersection of the any two arbitrary score lines.
